(19) United States
(12) Patent Application Publication
(10) Pub. No.: US 2009/0199472 A1
(43) Pub. Date: Aug. 13, 2009

(54) Plant culturing tool

(75) Inventor: Mieko Ito, Yotsukaido-shi (JP)

Correspondence Address: FLYNN THIEL BOUTELL & TANIS, P.C., 2026 RAMBLING ROAD, KALAMAZOO, MI, 49008-1631, US

(73) Assignee: MIEKO ITO, Yotsukaido-shi (JP)

(21) Appl. No.: 11/665,614

(22) PCT Filed: Oct. 19, 2005
(86) PCT No.: PCT/JP05/19202

§ 371 Date: Mar. 23, 2009

(30) Foreign Application Priority Data
Oct. 20, 2004 (JP) 2004-305404

(51) Int. Cl. A01G 9/02; B65D 85/52

(52) U.S. Cl. 47/65.6; 206/423; 47/65.5

(57) ABSTRACT

The invention is to provide a planter that does not need to use a saucer or the like; said planter can be used as a planter after the content thereof is gone; the leakage of the content (soil and the like) at the distribution thereof is eliminated. The planter comprises a planter body including an air space capable of containing a plant cultivating material, wherein said planter body includes at least one drainage opening for draining a solution pored into said air space, said drainage opening being liquid tightly occluded by an occluding member, said occluding member being operatively provided for optionally opening or occluding said drainage opening from the outside of said planter, thereby realizing the planter.

### TECHNICAL FIELD

The present invention relates to a planter used for cultivating plants, in particular, to a planter that is characterized by its drain configuration for draining water or another solution required for the nurse of the plants.

### BACKGROUND OF THE ART

Conventionally, a gardening pot has been generally used as a planter, and in the commercially available gardening pot, some holes for draining water are usually formed at the bottom surface. These draining holes are formed to avoid problems such as root rot caused by that the root of the plant is always exposed to water, that is to say, it is recognized to be a essential configuration in the general planter (except for that used for water cultivation).

Since these draining holes are formed such that they are opened all the time to improve the drainage of plant cultivating materials such as soil, in general, another container (e.g., saucer) for receiving solution flowing out of the draining holes is also required.

In Patent Literature 1, a flow pot that does not need such a saucer is proposed against this conventional gardening pot. In this Patent Literature 1, it is an object to save the trouble of carrying the plants; the saucer should be carried together with the gardening pot, and the saucer is eliminated by forming an air space capable of holding water contents to the inner bottom surface of the gardening pot.

Further, since at the start of the plant cultivation in the prior art, it has been recognized that the container used for cultivating the plant (except for that used for water cultivation) must include draining holes or the air space capable of holding water contents as described in Patent Literature 1 in above, there is a need to prepare the commercially available planter for cultivating plants.

Therefore, the container that can be reused as a gardening pot proposed in the prior art also include draining holes opened all the time as described in above, for example, in Patent Literature 2, a container in which holes are once opened at the bottom which will act as a draining hole when the container is used as a flow pot has been proposed, as well as, a dish that may become a gardening pot by opening a through hole at the bottom proposed in Patent Literature 3.

Moreover, for a product with which the plant cultivation can be more easily started, conventionally, a planter in which plants are previously cultivated is proposed. However, since such a product is in a not a little risk of the leakage of the content during the distribution thereof, it is needed to be further improved.

Further, Patent Literature 4 (Japanese Utility Model No. 3100688) discloses a pot like container in which a penetrated hole is formed at the bottom of the pot like container body in the top to the bottom direction for retaining the water content in the pot like container and a soft plug is provided to the penetrated hole. However, since this container disclosed in the above literature is generally only to retain the water content in the container, there is no consideration to eliminate the need of the conventionally used saucer or the proper drainage condition required for the growth of plants.

### [Patent Literature 1] Japanese Utility Model No. 3064095

[Patent Literature 2] Japanese Utility Model Unexamined Publication No. H06-76141

### [Patent Literature 3] Japanese Utility Model No. 3066390

### [Patent Literature 3] Japanese Utility Model No. 3100688

### SUMMARY OF THE INVENTION

### Problem to be Solved by the Invention

The present invention is to provide a planter which can eliminate the need to use the saucer independently used of the planter as well as to solve the loss of the appearance due to the dirty saucer or inconvenience at carrying thereof.

Also, the present invention is to provide a planter which can eliminate the need to use the saucer as described in above and can be mounted to a pot cover or disposed therein.

Further, the present invention is to provide a planter in which the water required for the growth of plants can easily and effectively managed.

Moreover, the present invention is to provide a product which can be used as a planter and the like after the use of the contents therein (after the contents has gone) without apply modification thereto largely.

As well, the present invention is to provide a planter which can eliminate the risk of the leakage of the contents (soil or the like) thereof at the distribution.

### Means for Solving the Problem

The present invention provides a planter including draining holes capable of draining the excess water contents and the like as desired to solve the problem in above.

That is, the planter in accordance with the invention is formed by using a planter body including an air space capable of containing a plant cultivating material, said planter body comprising at least one of drainage opening for draining a liquid pored into said air space, said drainage opening being liquid tightly occluded (the sealed condition where the liquid can not be leaked) an occluding member said occluding member is provided so as to be operably from the outside of said planter body for optionally opening or occluding said drainage opening.

The planter body described in above may be in any form so long as it includes the air space for containing the plant cultivating material, for example, soil such as compost; plant cultivation gel; hydro ball; color sand; fertilizer; or water for water cultivation. For example, the planter body may be formed into a cylinder, column, or spherical shapes in which all surface are occluded, other than a cylinder having an opened upper end portion and the closed bottom (regardless in a cylinder or up side downed cone, including a tube like shape) as the commercially available flower pot. When the planter body is formed into the shape in which all surfaces are closed (i.e., no opening for planting a plant formed), a planting opening can be formed for planting plants by cutting and opening any one portion (or one surface).

Further, the material forming this planter body is not specifically limited and the planter may be produced by ceramics, resins or metals. Provided that when the planter body is formed by woven cloth, it is desirable that the woven cloth is previously applied the required water proofing. In particular, it is desirable to form the planter body to form by using a synthetic resin because of its easiness of processability and sufficient flexibility.

Also, various solutions such as water or nutritional solutions for the growth of the plants will be filled with said air space after the plants are planted to the plant cultivating material. Although the regulation of such solutions, in particular the supply rate of water, must be performed under the consideration of the weather, temperature and humidity of the date, there can be a case where too much water is supplied to the plant to be grown since the regulation for proper rate is generally difficult. In such a case, the excess water is remained in the container, root roe and the like may be occurred.

Therefore, in the planter body of the invention, at least one drainage opening for draining solutions pored into the air space is formed. Said drainage hole may be provided as one or two or more of openings. When a plurality of openings is provided, each opening may be disposed so as to be apart from one another. Also, though the drainage openings may be formed to have a dimension such that from which the solution can be drained, the dimension is preferably less than 15 mm in the diameter or the longer diameter. When the diameter or the longer diameter is 15 mm or more, there may be fear that the plant cultivating materials such as soil is also discharged, which will raise the need to control the discharge of the plant cultivating materials with a separate net or the like. However, when the drainage openings are covered by a porous member such as a net (for example, it is desirable that a water permeable member such as sheet) to control the discharge of the plant cultivating material, the drainage openings are formed to be large as much as possible, for example, having 15 mm or more of diameter or longer diameter. Furthermore, regardless the dimension of the drainage openings, when they are covered with the porous member such as a net, it is ensure that the discharge of the plant cultivating materials can be prevented, it is a desirable condition. While when the drainage openings are formed to have a dimension of less than 15 mm in the diameter or the longer diameter, each drainage opening may be disposed into a sieve, which can be realized by integrally forming the drainage openings with various porous members such as a sieve member.

Moreover, though these drainage openings may be provided at any position in the planter body, it is desirable that they are provided in the lower half area of the planter body in the use thereof as a planter. More preferably, in the use thereof as a planter, the drainage openings are formed in the area to be the lower end surface of the planter body because the excess solutions to effectively be drained are accumulated at the lower side of the planter body. Also, the drainage openings share the inner wall surface forming the air space in the air space for containing the plant cultivating materials, or are formed into recessed portions (including portions obliquely projecting toward the outside) at the inner wall surface (including the bottom surface). This is for improving the drainage property within the air space.

The drainage openings is, then, liquid tightly occluded by the occluding member. Accordingly, the planter can be configured in which sudden effusion of the excess solutions pored into the air space and the need of a saucer are eliminated, thereby safely disposing it.

This occluding member is formed as a separate dedicate body such as a cap to occlude, alternatively, it is formed into one portion (a second portion as described in below) to be used as a platform when the planter body is dividably formed as described in below.

Particularly, when the occluding member is formed into a separate body from the planter body, said planter body includes an opening for planting into said air space and a drainage opening for draining solution pored into the air space, said drainage opening is liquid tightly occluded by the occluding member separately formed from the planter body, said occluding member capable of opening and closing said drainage opening from the outside of the planter body and forming the bottom of the planter, thereby providing the planter.

Also, said occluding member can be used to act not only to occlude the drainage openings but also to stand the planter body as a pedestal or supporting member. When the occluding member has further function as the pedestal or supporting member, the bottom surface of said occluding member is formed to include a flat surface so as to be stable as placed on a platform.

Particularly, said occluding member is provided such that said drainage openings can be operated to open or occlude from the outside of said planter body while the air space is willed with the plant cultivating materials. That is, even though the air space is filled with the plant cultivating materials, the drainage openings can be opened or occluded by this operation from the outside of the planter body. The occluding member in this way, for example, may be provided so as to be freely detachable from the planter body relative to the drainage openings or may be coupled to an operation pole provided at the outside of the planter body to interact therewith to open or occlude the drainage openings. However, since this occluding member is required to be formed to liquid tightly occlude the drainage openings as described in above, it may be formed by an elastic member capable of tightly contacted with the drainage opening to the level where the liquid tight seal therebetween can be secured, or may be formed with a structure for securing the liquid tightness (for example, engagement structure complementally engaged with the tip end portion of the drainage openings protruding toward the planter body).

In particular, this occluding member is preferably formed to occlude the openings without entering the drainage openings. That is, it is desirably formed into a configuration of a lid to cover the drainage openings. When the occluding member is formed to fit into the drainage openings (that is, a plug structure), it may be occurred that not a few silt and the like is adhered to the wall surfaces of the drainage openings at drainage which will provide gaps to cause water leakage. Moreover, it can be considered that when the plug is fitted into each drainage opening, its fitting structure may be lost during the repeat of fitting and releasing the plug which will also provide a gap to cause the water leakage.

Accordingly, the planter configured in accordance with the invention as described in above, since the drainage openings are liquid tightly occluded by the occluding member, it can be eliminated that the solutions (water or nutritional solutions, etc.) pored into the container (air space) are suddenly discharged, thereby excluding the need of the saucer as in above. Also, since the occluding member to occlude the drainage openings is formed such that it can be operated to open or occlude the drainage openings from the outside of the planter body, even though the excess solution is pored thereto, the drainage openings can optionally be opened to discharge the excess solution.

The plant cultivating container in accordance with the invention may desirably be provided with the following configuration or structure.

That is, in the planter in accordance with the invention, the planter body is provided with a separating structure for separating the planter body into a first portion in which said drainage openings exist and a second portion in which no drainage opening exists, whereby the planter can be provided in which an opening for planting as a plans planting inlet is appeared at said first portion.

When the planter body is separated by said separating structure, in the first portion in which said drainage openings are existed, the planting openings as a plants planting inlet is appeared. That is to say, this first portion is used for planting plants and will have an air space capable of containing plant cultivating materials. On the other hand, the second portion, though it does not have a specific application, it is preferably used as a pedestal or a supporting member for standing and supporting said first portion. When the second portion is used as a pedestal or a supporting member, it is preferred to form the first portion so as to be engaged with the separating surface of the separated second portion. The configuration for the engagement of the first portion with the separating surface of the second portion is intended to be a shape that can combine both portions by various engagement ways such as helical engagement, fitting, bonding or the like. Further, when the second portion is used as a pedestal or a supporting member, said second portion may be provided with the occluding member for liquid tightly occluding said drainage openings unitary formed therewith.

The separation of the first portion from the second portion may be performed at any position so long as the position where the air space capable of containing the plant cultivating materials can be secured in at least the first portion side. For example, when the planter body is formed into a cylindrical shape having all surfaces occluded, the drainage openings may be formed at one end surface in the axial direction as well as the other end surface may be separated to open. Alternatively, at the portion where the predetermined area in the axial direction having no drainage openings formed can be separated, said separation structure may be provided. In this way, when the predetermine area in the axial direction of the planter body is formed so as to be separatable, the separation structure may be formed by rotating the peripheral surface of said planter body.

For the separation structure, any structures may be included, for example, a structure formed so as to be more fragile than the other portion by grooves or linear sections (slits); a structure of the seal like second portion provided so as to seal an opening portion (or a slit) of the planter body that is previously formed; a structure that can be cut by a scissors or knives; or a structure in which the first and second portions previously separated can be connected to each other by a tape or another adhesion member and optionally released said adhesion member, and so on.

Further, the planter in accordance with the invention can previously contain at least the plant cultivating materials in the air space of the planter body. When the plant opening is existed at first time, the plant cultivating material may be received by a separated bag or other container and, then, disposed within the air space. While when the air space of the plant body is formed as a sealed space that can optionally be opened, the cultivating material may be previously received as it is or after filled into a container such as a separated bag and, then, received by that air space capable of optionally being opened. Particularly, when the air space is formed as the sealed space, the container can immediately be used only by opening said space by the user as well as since the space is occluded prior to the use thereof, there is no fear of leakage of the plant cultivating materials such as soil of the contents at the distribution phase. Preferably, in the cultivating materials received within this space, seeds or bulbs of a plant is planted. For the structure that can optionally open the air space, the separation structure described in above may be employed.

With the planter previously containing the plant cultivating materials in the air space of the planter body in this way, such a planter can also effectively be utilized as a commodity for promotion by including the seeds of the plant and the like into the plant cultivating materials or by accompanied therewith as a separated body. When the planter is used for promotion, to the surface of the planter, advertisement, commercials, or company name or logo marks can suitably be applied. Also, when the planter is used for promotion, since the cultivated plant is primary decorated for appreciation, the planter is naturally paid attention of an observer, the advertisement applied to the planter will be sufficiently recognized, thereby naturally increasing the advertisement effect.

Furthermore, the planter in accordance with the invention may be employed as a container for containing or packing a content selected from food and drink, seasonings, detergents, cosmetics, and another daily necessity. That is, after the container is used as a container for containing food and drink, seasonings, detergents, cosmetics, it can be employed as a planter. By using such a container (i.e., the planter of the invention), that container that should be simply disposed in the prior art can be reused as a planter, therefore, the container of the invention can be beneficent to resource protection. Also, since a trade name and the like is shown in such a container, the effectiveness of the decoration can be improved when used as a planter by devising a design, at the same time, since the trade name and the like together with the planted plant can provide good impression to the observer, the advertising effect regarding that commodity can be shown.

Further, the planter in accordance with the invention can be employed as a vase for containing cut flowers, in this case, water exchange can be performed from the drainage openings without changing the arrangement of the flowers, therefore, the container is advantageous of using as a vase.

Moreover, the planter in accordance with the invention, primary provided as a container for cultivating plants, may be used as a small case for stationary or glossary and the like. Particularly, since the planter in accordance with the invention can eliminate the need of a water saucer and improve the decoration effectiveness, the container can sufficiently be accommodated to the application of the small case.

### BEST MODE FOR CARRYING OUT THE INVENTION

The embodiments of the planter in accordance with the invention will now be explained in detail with the reference to the drawings in below. However, the invention is not intended to limited to the embodiments.

### Embodiment 1

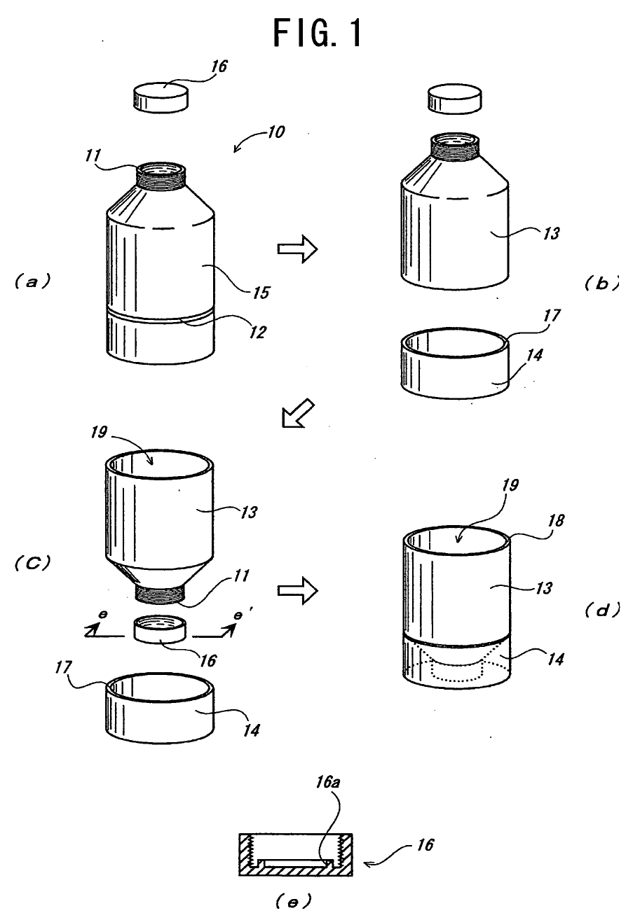

FIG. 1 is a schematic flow chart generally illustrating an instruction for use of the planter in accordance with one embodiment of the invention. A planter 10 shown in this figure is formed into a generally cylindrical shape as a whole in which the side where drainage openings 11 is existed is configured into a frustconical shape. The drainage opening 11 is used for an outlet of a content contained therein. The planter 10 as illustrated in this embodiment is provided with a cut off part 12 (fragile portion) 12 (FIG. 1a) formed so as to circulate in the circumferential direction at a portion apart from the drainage opening 11, whereby a planter body 15 is stripped from the planter by this cut off part 12 (i.e., separation structure 12), for example, a means such as a pull-tub to separate it into a first portion 13 where the drainage opening 11 is existed and a second portion 14 where no drainage opening is existed (FIG. 1b). Then, the first portion 13 is positioned with its bottom up and the drainage opening 11 is liquid tightly occluded by a occluding member 16 using a lid of a container, then, it will be fitted within a separation opening 17 of the separated second portion 14 (FIG. 1c). Accordingly, the first portion 13 provided with the drainage opening 11 at the lower side can stably be placed on a platform or a desk (FIG. 1d).

In the first portion 13 disposed in this way, since an opening 18 formed by separating looks up, from which a plant cultivating material or nutrition such as soil or water can be put into the planter 10 (particularly in an air space 19), while the opening 18 may be used as a plant planting opening (i.e. planting opening 18).

In this embodiment, the end surface of the separated first portion 13 (end surface at the side where the drainage opening 11 is existed) is in the shape protruding toward the outside to be a frustconical shape (hollowed inside) and the drainage opening 11 is formed to the hollowed end surface inside. Therefore, even though a solution (water) more than required is pored into the air space 19, the excess solution is effectively collected to the drainage opening 11, thereby improving the drainage efficiency. In this point, if water is accumulated in the area where the water is not drained, root roe will be occurred in this area to make the cultivation of the plant difficult. On the centrally, in the present invention, since no water is accumulated in the area where the water is not drained in that way, a planter with which a plant can be grown in health can be realized.

To the inside of the occluding member 16 (cap) for occluding this drainage opening 11, an annular portion 16a to tightly contact with the inner peripheral surface of the tip end of the drainage opening 11 (FIG. 11e), thereby liquid tightly occluding the drainage opening 11. Therefore, there is no leakage of excess water content and the like so long as the occluding member 16 is intentionally taken off. FIG. 1e is a cross sectional view of FIG. 1c at e-e line.

The planter 10 in this embodiment, as finally shown in FIG. 1c, at the lower end side of the planter body 15, the drainage opening 11 is presented, while at the upper end side, the air space 19 is opened to use thereof. In this air space 19, the plant cultivation material such as soil or water, if water cultivation, in general is filled and seeds or bulb of plants are planted. When water is pored to the air space 19 or the water for water cultivation is exchanged, the excess water or the water to be exchanged can be discharged from the drainage opening 11 by taking out the occluding member 16.

Also, the planter 10 can be used as a vase for receiving cut flowers, in this case, water exchange can be performed from the drainage opening 11 at the lower side without displacing the arranged flowers, therefore realizing advantageous vase.

The planter 10 as shown in the embodiment can be liquid tightly occluded and includes the drainage opening 11 capable of discharging the water within the air space by optionally opening, which, therefore, will become the planter suitable for the growth of the plants other than the convenient for the use thereof. That is, at the cultivation of the plants, supplying water includes the delivery of fresh air and when the air can not be replaced, root roe may be caused which is undesirable for the growth of the plants. In this point, at the cultivation of plants, in particular, water cultivation or a dual-bottom-surface water absorption cultivation (plant cultivation with a pot having a reservoir at the bottom for improving interior application), the water is retained within the planter the air exchange can not be easily performed, resulting in causing problems such as root roe. On the other hand, in the planter in which the drainage opening is provided to smoothly exchange the water in the air space in accordance with the invention, the stale air in the pot (in the soil or water) can be discharged from the bottom at the supply water and fresh air can be supplied, as well, which is desirable for the growth of the plants. Further, since the drainage opening included in the planter 10 in accordance with the invention can be liquid tightly occluded, the effect of the improvement of the decoration can be provided as well as the merit on the growth of the plants is secured.

Also, the air space 19 of the drainage opening 11 is preferably covered by a net, not shown, to prevent the particulate plant cultivating material such as soil from flowing out at the drainage.

Further, the planter 10 is comprised by the first and the second portions which are previously formed separately and assembled by adhesive tape, other coupling means or coupling process. When the first and the second portions are separated, the coupling means or coupling process can be released by pealing off this tape. In this case, this tape, the coupling means or coupling process correspond to the separation structure.

### Embodiment 2

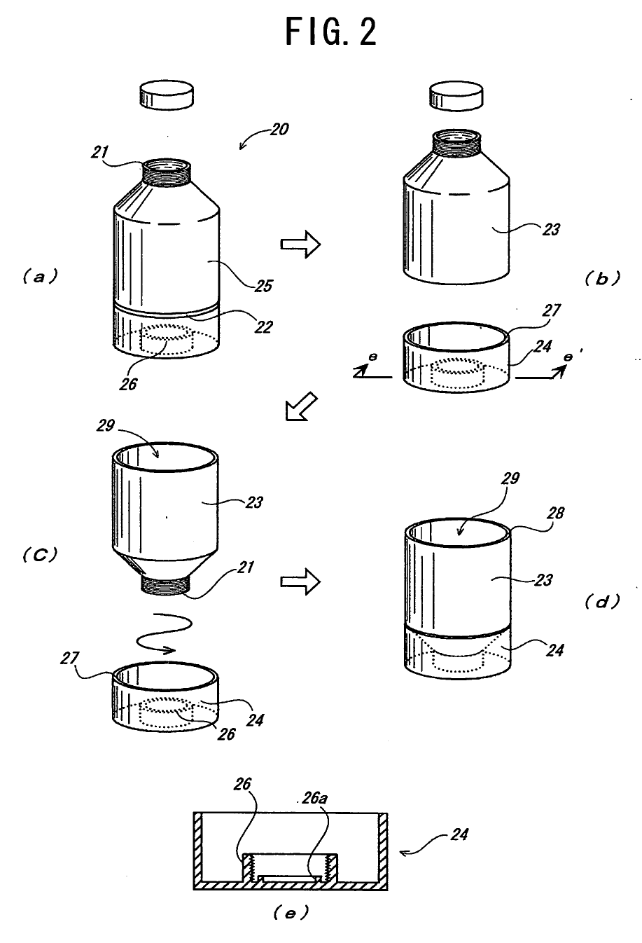

FIG. 2 is a schematic flow chart illustrating the use of a planter 20 in which an occluding member 26 of a drainage opening 21 is formed as one portion of a second portion 24.

That is, in the planter 20 in this embodiment, the occluding member 26 of the drainage opening 21 is previously provided in the inside of the air space of the container (FIG. 2a), whereby the need of the use of a lid in the container 20 is eliminated. Similar to the embodiment shown in FIG. 1, the planter body 25 is separated at a cut off portion (i.e., separation structure 22) into a first portion 23 in which the drainage opening is presented and a second portion 24 including the occluding member 26 (FIG. 2b). Then the drainage opening 21 of the first portion 23 is faced to down and helically fitted with the occluding member 26 within the second portion 24 (FIG. 2c), then, the opening 21 is liquid tightly occluded and the first and the second portions 23, 24 are integrated (FIG. 2d). Accordingly, even with the first portion 23 provided with the drainage opening 21 at the lower side, the container can be stably placed (FIG. 2d).

The occluding member 26 formed to this second portion 24 also includes an annular portion 26a that can be tightly contacted with the inner peripheral surface of the tip end of the drainage opening 21 (FIG. 2e), thereby liquid tightly occluding the drainage opening 21. FIG. 2e is a cross sectional view of FIG. 2b at e-e line.

For the like members in FIG. 1 are indicated by the numerical references same as those in FIG. 1 plus 10s before the corresponding numbers and the detailed explanations thereof are omitted. In this embodiment, the net can also be used to prevent the particulate plant cultivating materials such as soil from being flowed out at the drainage as well as the use of the separation structure such as a tape.

### Embodiment 3

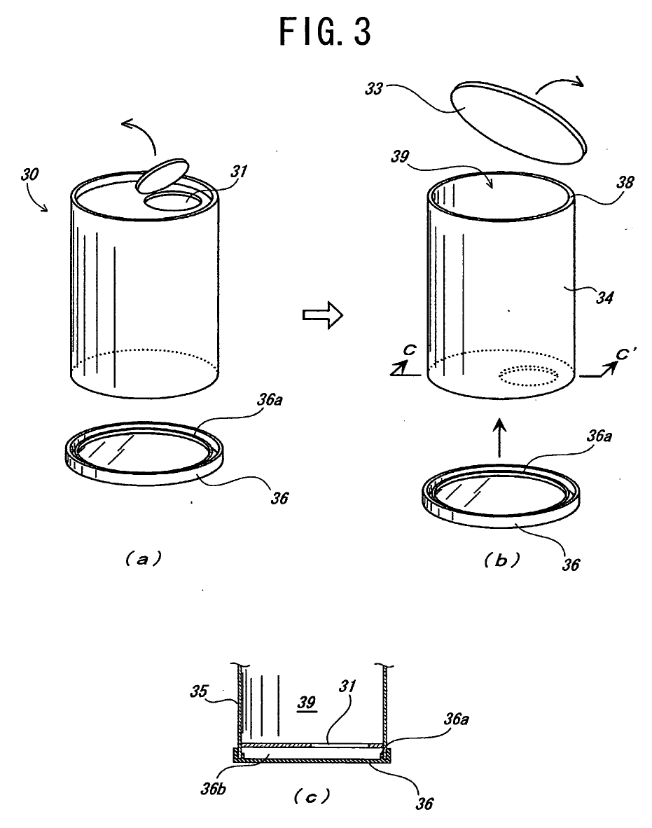

FIG. 3 is a schematic flow chart illustrating the use of the planter 30 that is form into a cylinder in which the planting opening 38 for the plants can be appeared by taking off the end surface thereof.

In FIG. 3, a planter body 35 including an air space 39 capable of containing the plant cultivating material is formed into a cylindrical shape, in which the one end portion in the axial direction is provided with a drainage opening 31 for draining a solution such as water pored into the air space 39 (FIG. 3a). Also, the drainage opening 31 is faced to down at the use thereof as a planter 30 and is liquid tightly occluded from the outer environment by a cap (occluding member 36) separately appended to the planter 30. More specifically, the end surface at the side where the drainage opening 31 is formed is occluded by the cap like occluding member 36, whereby the sudden flow out of the solution from the drainage opening 31 can be avoided. At that time, the flowed out solution from the drainage opening 31 will flow into the solution containing space 36b communicated with the air space 39 and the drainage opening 31 in the planter body 35, however, a case segmenting the solution flow-in space 36b (i.e., cap 36) is detachably provided to the planter body 35 and the engagement portion between the case 36 and the planter body 35 is liquid tightly occluded, whereby the solution flowed into the solution containing space 39 is not leaked to the outside (FIG. 3c). The case 36 and the planter body 35 may be engaged with each other by any engagement methods such as helical engagement, fitting, bonding or the like.

The end surface 33 opposed to the end surface where the drainage opening 31 is formed is cut by, for example, a cutter, a scissors, a can opener or other cutting means to show the plant planting opening 38. Also, the plant planting opening 38 may be occluded by a seal previously prepared and the seal can be released to show the plant planting opening.

In the planter 30 configured in this way, at the use thereof, the plant cultivating material such as soil is filled into the air space 39, seeds or seedlings of plants are suitably planted and solutions required for the growth of the plants such as water or fertilizing solution are supplied from the plant planting opening 38 as required. Then, when the excess solution is supplied, the occluding member 36 can be periodically taken off to drain the excess solution from the drainage opening.

In this embodiment, for the like members in FIG. 1 are indicated by the numerical references same as those in FIG. 1 plus 20s before the corresponding numbers and the detailed explanations thereof are omitted.

### Embodiment 4

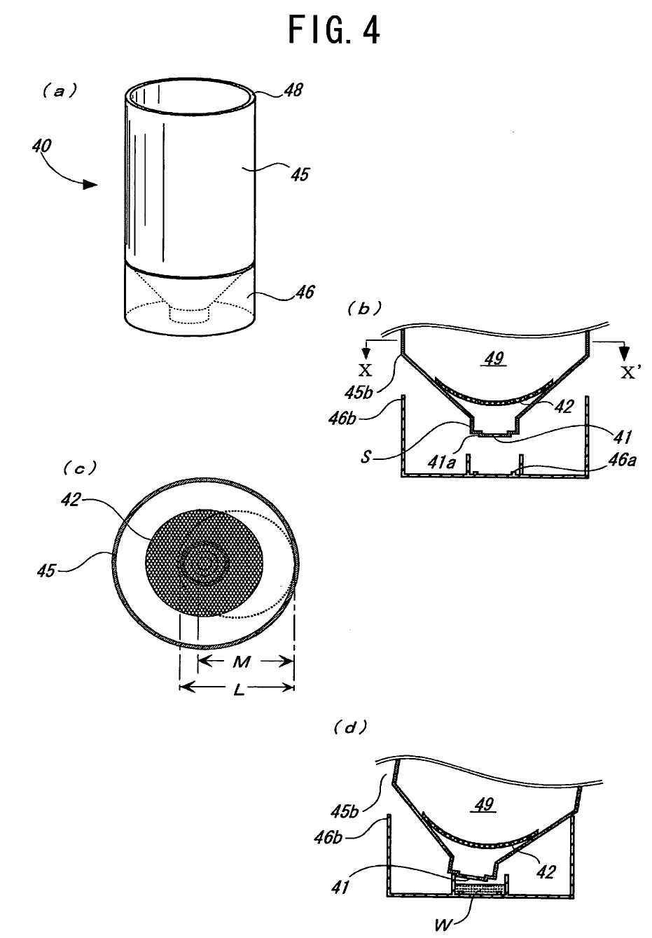

FIG. 4a is a perspective view illustrating the planter 40 in accordance with the invention; FIG. 4b is an end view at the cross section illustrating the structure near drainage opening 41; FIG. 4c is a perspective view at X-X′ in FIG. 4b; and FIG. 4d is an enlarged cross sectional view illustrating the principal part in the using condition at the drainage.

The planter 40 shown in FIG. 4 a planter body 45 formed into a tube with a planting opening 48 exposed at first time and a lid part that can liquid tightly occlude the drainage opening 41 formed at the bottom of the planter body 45, whereby it can be provided to cultivate plants as it is.

The planter body 45 is formed by using a flexible resin made tube having the bottom surface downwardly inclined and a cavity at the tip end with the drainage opening 41 formed at the center. That is, the drainage opening 41 is formed in the concaved area in the air space 49. The drainage opening 41 is covered by a member 42 having water permeability at the side of the air space 49. By the presence of the water permeable member 42, the leakage of the cultivating materials such as soil filled in the air space 49 is prevented from being flowed out. The water permeable member may be integrally formed with the drainage opening when the planter body 45 is formed by a resin.

The water permeable member 42 may be formed into a disc like sheet body as shown in this embodiment, for example, or other spherical shape or another three dimensional shapes. Particularly, it is preferred that when the member 42 is formed into the disc like shape as shown in this embodiment, the diameter L is sized so as to cover the drainage opening 41 all the time. That is, though this water permeable member 42 is required to be disposed to cover the drainage opening 41 all the time, it is inserted from the planting opening 48 side of the planter body 45, which will lead the positioning thereof difficult. Therefore, it is desirable that, for example, the diameter L of the water permeable member 42 is sized to be longer than the length M obtained by adding the radius of the planter body 45 to the radius of the drainage opening 41, thereby covering the drainage opening 41 all the time as shown in FIG. 4c. Further, as shown in FIG. 4c, the water permeable member 42 can be slightly bended to always be presented at the center of the bottom surface of the planter body 45 with respected to the inclination of the bottom surface. This water permeable member 42 will be shifted to the position where it covers the drainage opening 41 when compost and the like is loaded to the air space 49 that will push the member 42.

The occluding member 46 in this embodiment does not only occlude the drainage opening of the planter body 45 but also acts as a leg (the bottom) for improving the placing stability of this planter. By using the occluding member as a leg, when the water presented within the air space 49 is drained, as shown in FIG. 4d, the excess water W is accumulated within the occluding member by raise up the planter body 45 to lean against the side wall, then, the drainage operation is completed only by disposing the accumulated water. Therefore, the planter with which the drainage operation can easily be performed is realized.

The connection of the planter body 45 to the occluding member 46 may be carried out with a side wall 46b of the occluding member 46 and a side wall 45b of the planter body 45, alternatively, or may be performed in the area S near the drainage opening 41, or both can be applied. At this connection, fitting structure, threaded structure or other various structures may be employed.

Then, in order to realize the occlusion securing the liquid tightness of the drainage opening 41 by this occluding member 46, an outwardly protruding portion 41a with a step is formed around the drainage opening 41 and the occluding member 46 is provided with an annular portion 46a complementarily receiving that step. That is, in this embodiment, the combination of this stepped portion 41a and the wall portion 46a provides the secured liquid tightness to prevent the water pored into the air space 49 from leaking.

In the planter formed in this way, though water is suitably pored into the air space 49 to cultivate the plant planted within the air space 49, the water is not leaked to the outside of the planter until the occluding member 46 is taken off. Therefore, the planter in which the need of a saucer for water is eliminated as well we which can be decorated to any place can be realized.

Further, since the planter body is formed by using a flexible tube in the planter, the production thereof is easy; it has a light weight and shock resistance; it is convenient to use. Any materials for producing the tube may be employed, for example, metals or ceramics other than resin.

### Embodiment 5

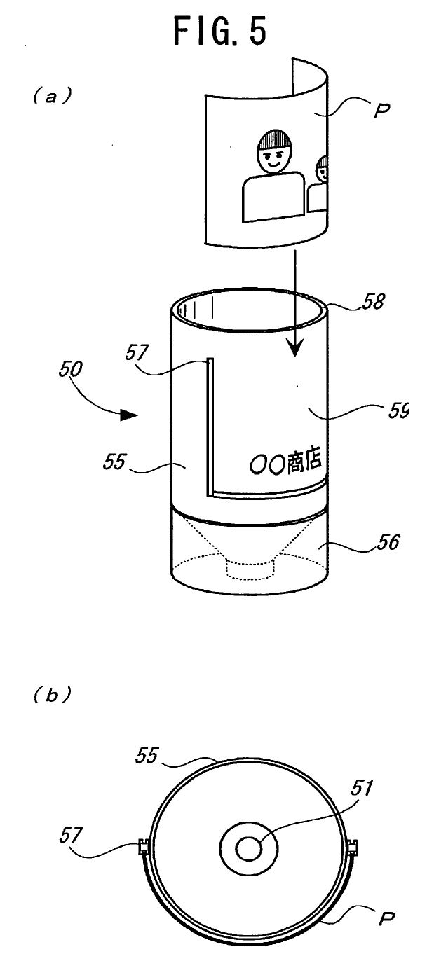

FIG. 5 includes a side view (FIG. 5a) and a plane view (FIG. 5b) of the planter to which a decoration area 59 to which any design of the user's favorite may be applied is provided at the side surface thereof. In particular, the planter 50 is realized such that, in this decoration area 59, a photo of one's family or a favorite illustration may be placed and the decoration area 59 is secured as an area sandwiched by a frame 57 with which a photo or an illustration P is fitted.

This decoration area is of the area where the user's favorite photo or illustration P is placed. After placing the photo or illustration is placed, this area is hidden thereby. Therefore, the planter is in the distribution phase, the area may be used as an area for indicating the distributor's commercial or messages. For example, when the planter 50 is used as a promotion item by the distributor, an advertisement of the distributor can be indicated in that area. Alternatively, when the planter 50 is used as a present given to guests at a wedding banquet or as a memento of one's birth, letters indicating thereof or photo or other design may be applied thereto.

Particularly, this frame 57 is preferably provided with grooves for fitting the photo at both sides. By forming the frame 57 in this way, different photos or illustrations can be disposed at the front surface side and the top surface side as placed.

Further, this decoration area 59 may be secured as an area to which stickers of one's favorite prepared by a personal computer and a printer may be attached without providing the frame as described in above. In this case, the planter 50 can be provided with a giving sticker with a mount thereof and the like. The design to be applied to the decoration area may be selected though a telecommunication circuit such as the internet to provide the planter 50 with the selected design can be provided. In this case, of course, a system configured by including a server having various design data stored in a storage area and a client (PC) connected to the server though a telecommunication device should be provided.

Particularly, in the planter in accordance with the invention, since the drainage opening is always liquid tightly occluded, it can be placed on a desk in a workplace with feel free. Further, since the planter does not need any saucer for water required in the conventional flow port, it can easily be moved when the planter should be moved to provide some place for desk work. As well as, the planter 50 shown in this embodiment has a function same as a photo stand at the side surfaces, thereby increasing the decorative effect.

In this embodiment, though the planter has been explained with respect to the embodiment of the planter of embodiment 4, this embodiment may be applied to the planters of embodiments 1 to 3.

### Embodiment 6

The planters 10, 20, 30, 40 and 50 shown in FIGS. 1 to 5 with the plant cultivating materials such as soil previously filled therein may be provided. Alternatively, the container containing or packing a various kind of products such as drink and food, seasonings, detergents, cosmetics and other daily necessities may be provided. The container can also be used as a container for containing stationary, glossaries, or other small items, not limited to the plants.

### BRIEF DESCRIPTION OF THE INVENTION

FIG. 1 is a schematic flow chart illustrating the use of the planter in accordance with the first embodiment of the invention.

FIG. 2 is a schematic flow chart illustrating the use of the planter in accordance with another embodiment of the invention.

FIG. 3 is a schematic flow chart illustrating the use of the planter in accordance with yet another embodiment of the invention.

FIG. 4 is a schematic view illustrating the planter in accordance with another embodiment of the invention.

FIG. 5 is a schematic view illustrating the planter in accordance with further embodiment of the invention.

### DESCRIPTION OF NUMERICAL REFERENCES

10, 20, 30, 40, 50: planter
11, 21, 31, 41, 51: drainage opening
12, 22, 32: separation structure
13, 23, 33: first portion
14, 24, 34: second portion
16, 26, 36, 46: occluding member
16a, 26a, 36a: annular portion

1. A planter comprised by a planter body including an air space capable of containing a plant cultivating material,
said planter body includes at least one drainage opening for draining a solution pored into said air space,
said drainage opening being liquid tightly and directly occluded by an occluding member such that said solution pored into said air space can not be leaked as well as said opening is occluded by a water permeable seat member at the air space side,
said occluding member being operatively provided for optionally opening or occluding said drainage opening from the outside of said planter.

2. The planter as claimed in claim 1, wherein said planter body comprises a planting opening for planting a plant into said air space; and a drainage opening for discharging the solution pored into said air space, said drainage opening being liquid tightly occluded by an occluding member differently formed from said planter body, said occluding member being capable of opening or closing said drainage opening from the outside of said planter body and being provided so as to form the bottom surface of said planter.

3. The planter as claimed in claim 1, wherein the connection of said planter body with said occluding member is carried out near said drainage opening, said occluding member being formed into a lid to cover said drainage opening.

4. The planter as claimed in claim 1, wherein said drainage opening is formed into a concaved portion (including a projecting portion inclined toward the outside thereof) in the inner surface of said air space.

5. The planter as claimed in claim 1, wherein said planter body is provided with a separation structure for separating said planter body into a first portion where said drainage opening is presented and a second portion where said drainage opening is not presented, in which a planting opening as a plant planting inlet is appeared in said first portion by said separating.

6. The planter as claimed in claim 2, wherein said planter body is formed into a column having an air space in the inside; said separation structure is formed around the peripheral surface of said planter body; the end surface side of said first portion is formed into a profile for engaging with the separating surface of the separated second portion.

7. The planter as claimed in claim 1, wherein said planter body is formed by a resin made flexible tube, in which the bottom side thereof is downwardly inclined, said body is provided with a concaved portion at the tip end and said drainage opening at the center thereof, said drainage opening being covered by a water permeable member at the air space side,
said permeable member is a disc like sheet body having a diameter longer than the length M obtained by the radius of said planter body and the radius of said drainage opening.

8. The planter as claimed in claim 1, wherein said occluding member occludes said drainage opening of said planter body as well as has a function as a leg for improving a placing stability of said planter, said occluding member further having a side wall, whereby said planter body can be raised up and leaned against said side wall.

9. The planter as claimed in claim 5, wherein said air space of said planter body is formed to be a sealed space capable of being optionally opened, at least the plant cultivating material is contained in said air space.

10. A product using said planter as claimed in claim 1 as a container for containing or packing a content; said product comprising said content selected from drink and food, seasonings, detergents, cosmetics and other daily necessities, and a container for containing or packing said content.
